(19) United States
(12) Patent Application Publication
(10) Pub. No.: US 2011/0039057 A1
(43) Pub. Date: Feb. 17, 2011

(54) LAMINATED COMPOSITE ROD AND FABRICATION METHOD

(75) Inventors: Douglas A. Frisch, Renton, WA (US); Marc J. Piehl, Renton, WA (US); Kava S. Crosson-Elturan, Bloomington, IN (US); Kirk B. Kajita, Newcastle, WA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 12/542,594

(22) Filed: Aug. 17, 2009

(51) Int. Cl. B32B 3/06; B32B 1/00; B32B 37/00; B32B 37/12; B32B 38/00

(52) U.S. Cl. 428/102; 428/375; 428/368; 156/60; 156/330; 156/325; 156/250; 156/154; 156/93

(57) ABSTRACT

A laminated composite rod includes a rod body having a generally circular or oval cross-section and comprising a plurality of laminated composite plies disposed at various orientations with respect to each other.

### TECHNICAL FIELD

The present disclosure relates to structural rods which reinforce structural panel stringers. More particularly, the present disclosure relates to a pre-cured laminated composite rod and a fabrication method for a laminated composite rod which is suitable for supporting structural panel stringers during resin infusion and curing of the stringers and which can be tailored to meet design requirements and reduce thermal stresses in a panel stringer by providing a reduced Coefficient of Thermal Expansion.

### BACKGROUND

The PRSEUS (Pultruded Rod Stitched Efficient Structure) structural design concept may require a rod to support the panel stringers during assembly, infusion and cure of the stringers. The rod used in the current panel stringer design may be made by a process-pultrusion- that results in the rod having all zero degree orientation fibers. This process may result in a rod with a higher stiffness and Coefficient of Thermal Expansion than is required in most design situations. The zero degree fibers running longitudinally may undergo diametric expansion and provide no constraint on resin expansion across the diameter of the rod during cure. This architecture of the rod may yield high residual cure stresses and result in cracking of the resin in the layer between the rod and the wrap ply.

Methods which have been proposed to improve the pultruded rod have included helical wrapping of the rod with fibers that are intended to partially constrain the resin expansion. These solutions, however, may remove only a small portion of the zero degree fibers and greatly increase the part cost for the pultruded rods. Moreover, the existing pultruded rod design may be attended by residual stresses in the rod-to-wrap interface of the panel stringer.

The conventional pultruded rod may be formed with all zero degree fibers and therefore, may be very stiff with little amenability to tailor the properties to meet different requirements. Additionally, the pultruded rod may exhibit a very high Coefficient of Thermal Expansion due to the 100% zero degree dominated architecture.

Therefore, a pre-cured laminated composite rod is needed which is suitable for supporting structural panel stringers during resin infusion and curing of the stringers and which can be tailored to meet design requirements and reduce thermal stresses in a panel stringer by providing a reduced Coefficient of Thermal Expansion.

### SUMMARY

The present disclosure is generally directed to a laminated composite rod. An illustrative embodiment of the laminated composite rod includes a rod body having a generally circular or oval cross-section and comprising a plurality of laminated composite plies disposed at various orientations with respect to each other.

The present disclosure is further generally directed to a rod stitched efficient composite structure comprising a stitched composite structure and a pre-cured laminated composite rod having a generally circular or oval cross-section and incorporated in the stitched composite structure.

The present disclosure is further generally directed to a laminated composite rod fabrication method. An illustrative embodiment of the method includes providing a plurality of composite plies, forming a laminated composite panel by laying down the composite plies, curing the laminated composite panel and forming a laminated composite rod having a generally circular or oval cross-section from the laminated composite panel.

In some embodiments, the rod stitched efficient composite structure comprises a skin panel assembly; a pre-cured laminated composite rod comprising a rod body including a plurality of laminated composite plies selected from the group consisting of graphite tape, epoxy tape and a prepreg material devoid of pultruded plies and disposed at different orientations with respect to each other in the rod body; and a rod stitched efficient structure panel assembly comprising a pair of adjacent stringer panels, a panel wrap connecting the stringer panels and extending around the laminated composite rod and a pair of panel flanges extending from the stringer panels and stitched to the skin panel assembly.

In some embodiments, the rod stitched efficient composite structure may include a skin panel assembly; a pre-cured laminated composite rod comprising a rod body including a plurality of laminated composite plies selected from the group consisting of graphite tape, epoxy tape and a prepreg material devoid of pultruded plies and disposed at different orientations with respect to each other in the rod body; and a rod stitched efficient structure panel assembly comprising a pair of adjacent stringer panels, a panel wrap connecting the stringer panels and extending around the laminated composite rod and a pair of panel flanges extending from the stringer panels and stitched to the skin panel assembly.

In some embodiments, the laminated composite rod fabrication method may include providing a plurality of composite plies selected from the group consisting of graphite tape, epoxy tape and a prepreg material and devoid of pultruded plies; forming a laminated composite panel by laying down the composite plies at various orientations with respect to each other; curing the laminated composite panel; forming a laminated composite rod from the laminated composite panel by cutting and machining the laminated composite panel; subjecting the laminated composite rod to surface abrasion; providing a rod stitched efficient structure panel assembly comprising a pair of adjacent stringer panels, a panel wrap connecting the stringer panels and a pair of panel flanges extending from the stringer panels; inserting the laminated composite rod in the panel wrap of the stringer; providing a skin panel assembly; stitching the pair of panel flanges of the stringer to the skin panel assembly; infusing resin into the stringer; and curing the stringer.

### BRIEF DESCRIPTION OF THE ILLUSTRATIONS

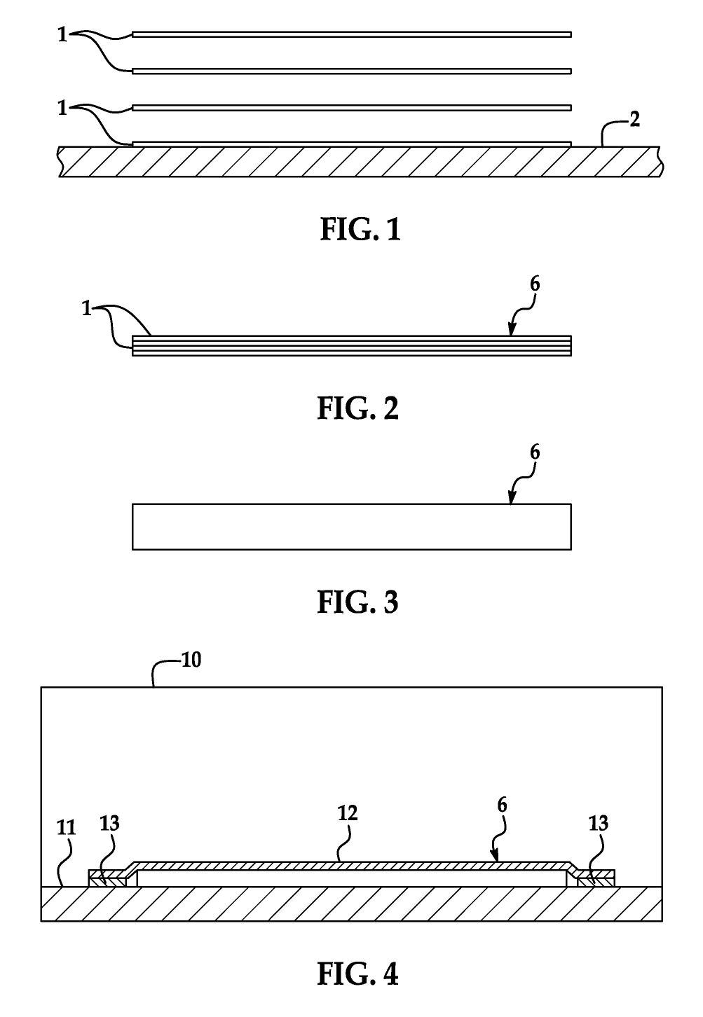

FIG. 1 is an exploded side view of multiple plies in construction of a laminated composite panel used to fabricate an illustrative embodiment of the laminated composite rod.

FIG. 2 is an edge view of the laminated composite panel.

FIG. 3 is a top view of the laminated composite panel.

FIG. 4 is a schematic diagram of the laminated composite panel vacuum-sealed in an autoclave for curing.

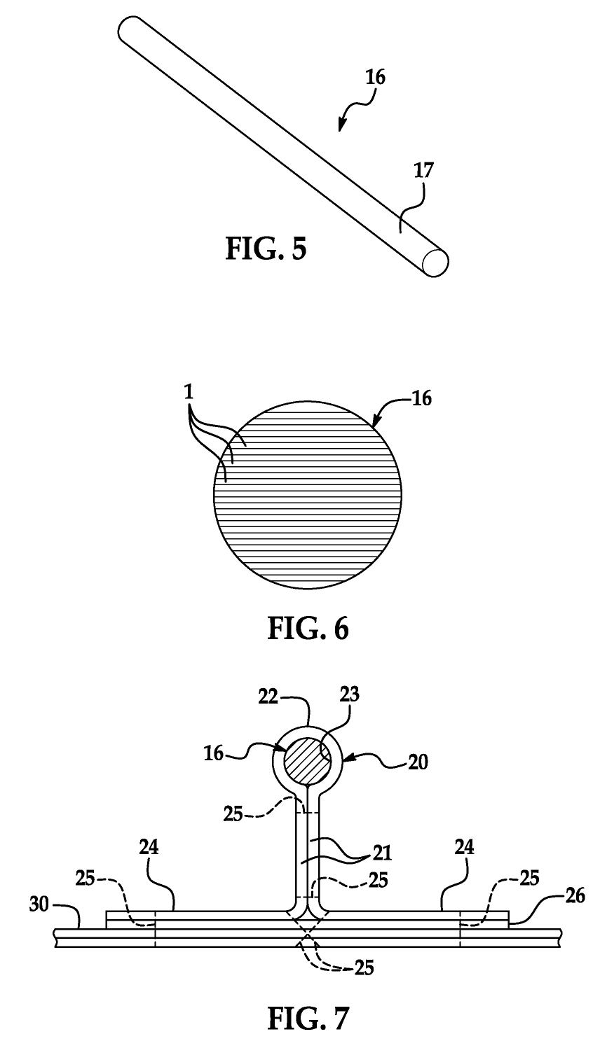

FIG. 5 is a perspective view of an illustrative embodiment of the laminated composite rod.

FIG. 6 is an end view of an illustrative embodiment of the laminated composite rod.

FIG. 7 is an end view of a panel assembly stringer attached to a skin panel assembly and in which an illustrative embodiment of the laminated composite rod is inserted.

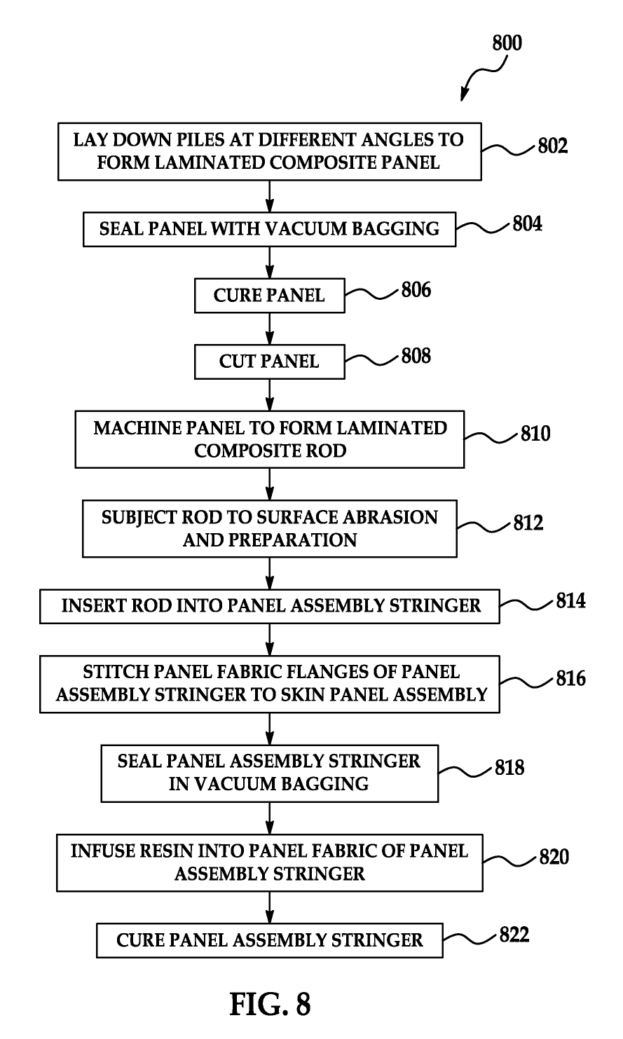

FIG. 8 is a flow diagram of an illustrative embodiment of a laminated composite rod fabrication method.

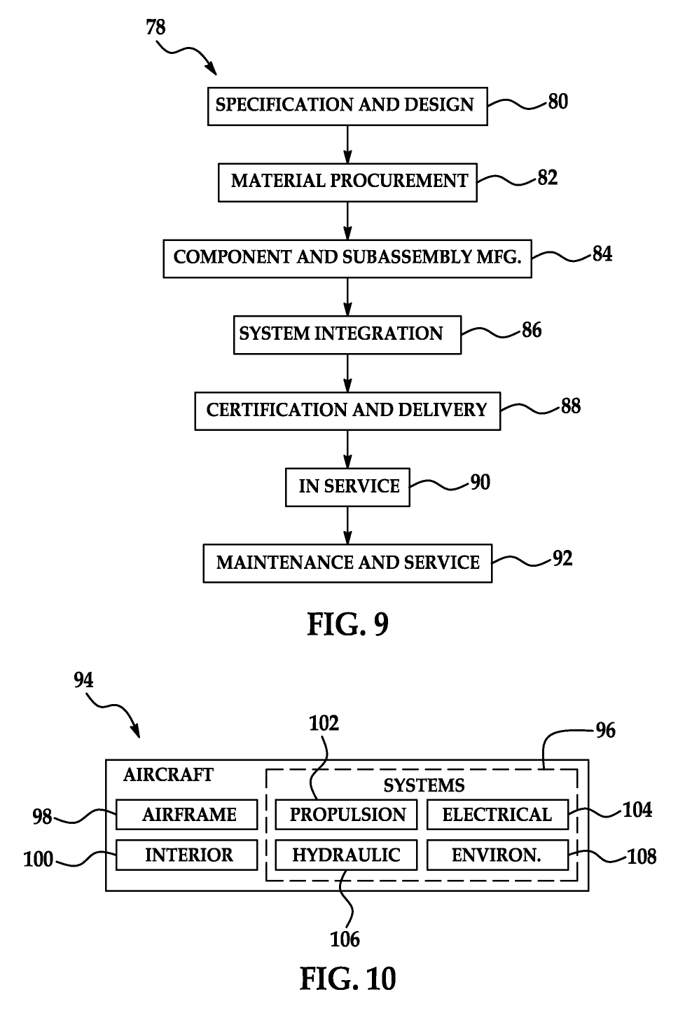

FIG. 9 is a flow diagram of an aircraft production and service methodology.

FIG. 10 is a block diagram of an aircraft.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, brief summary or the following detailed description.

Referring initially to FIGS. 1-6, fabrication of an illustrative embodiment of the laminated composite rod 16 (FIG. 6) is shown. As shown in FIG. 1, the laminated composite rod 16 may include a generally elongated rod body 17 which may have a generally circular or oval cross-sectional shape. The rod body 17 of the laminated composite rod 16 be fabricated by initially laying multiple composite plies 1 on a layup tool 2 to form a flat laminated composite panel 6 (FIGS. 2 and 3) which will ultimately form the laminated composite rod 16. Each ply 1 may be graphite or epoxy tape or other prepreg material, for example and without limitation and may be devoid of pultruded fibers. The plies 1 may be laid up at different angles or orientations to form the laminated composite panel 6 depending on the stiffness requirements of the laminated composite rod 16. The stiffness and other properties of the laminated composite rod 16 may be tailored by varying the number of plies 1 as well as the angles or orientations of the plies 1 with respect to each other as they are laid up to form the laminated composite panel 6. For example and without limitation, in some embodiments the plies 1 may be laid up in a sequence of consecutive directional layout of +45, 0, 90, 0, 90 and −45 degrees.

As shown in FIG. 4, the laminated composite panel 6 having the selected number of plies 1 laid up at various angles may next be cured such as by placing the laminated composite panel 6 on a panel support 11 in an autoclave 10. The laminated composite panel 6 may be sealed against the panel support 11 by securing vacuum bagging 12 around the perimeter of the laminated composite panel 6 with seal tape 13. The laminated composite panel 6 may be cured using standard processing techniques and parameters which are known to those skilled in the art.

After it is cured, the laminated composite panel 6 may be subjected to rough cutting to generally transform the shape of the laminated composite panel 6 into the shape of the laminated composite rod 16. Rough cutting of the laminated composite panel 6 may be accomplished using water jet techniques or suitable alternative techniques which are known to those skilled in the art. The laminated composite panel 6 may then be machined into the final desired shape of the laminated composite rod 16. In some embodiments, the machined laminated composite rod 16 may be subjected to surface abrasion and/or other surface preparation treatments. As shown in FIG. 6, the finished laminated composite rod 16 may include the plies 1 which were laid up into the laminated composite panel 6 (FIG. 2).

As shown in FIG. 7, the finished laminated composite rod 16 may next be inserted into a stitched composite structure such as a PRSEUS (Pultruded Rod Stitched Efficient Structure) panel assembly stringer 20, for example and without limitation. The panel assembly stringer 20 may be a composite fabric material which includes a pair of adjacent folded stringer panels 21 from which extends a pair of panel flanges 24, respectively. A panel wrap 22 may connect the stringer panels 21. The panel wrap 22 may extend around the laminated composite rod 16 such that the panel wrap 22 generally conforms to the geometry of the laminated composite panel 16. The panel wrap 22 may contact the laminated composite panel 16 at a rod-to-wrap interface 23. The stringer panels 21, the panel wrap 22 and the panel flanges 24 may form one continuous piece.

The panel flanges 24 of the panel assembly stringer 20 may be attached to a skin panel assembly 30. In some embodiments, the panel assembly stringer 20 may be attached to a base panel 26 which may be attached to the skin panel assembly 30. Stitching 25 may be used to attach the adjacent stringer panels 21 to each other and the panel flanges 24 to the skin panel assembly 30. After attachment of the panel assembly stringer 20 to the skin panel assembly 30, the panel assembly stringer 20 may be placed in a vacuum bag (not shown). Resin (not shown) may be infused into the fabric of the panel assembly stringer 20, after which the panel assembly stringer 20 may be cured.

The laminated composite rod 16 may be tailored to match varying structural requirements and greatly reduces the Coefficient of Thermal Expansion (CTE) between the pre-cured laminated composite rod 16 and the surrounding infused fabric portions of the panel assembly stringer 20. Moreover, due to the low CTE of the laminated composite rod 16, residual stresses may be substantially reduced during curing of the panel assembly stringer 20, reducing or eliminating interfacial cracking at the rod-to-wrap interface 23 of the panel assembly stringer 20. The laminated composite rod 16 may be designed with tailorable strength and stiffness characteristics for specific structural applications by varying the number, sequence and orientation of the laminated composite panel 6 (FIGS. 2 and 3) which are laid up to fabricate the laminated composite rod 16, as was heretofore described.

Referring next to FIG. 8, a flow diagram 800 of an illustrative embodiment of a laminated composite rod fabrication method is shown. In block 802, composite plies may be laid down to form a laminated composite panel. Each ply may be graphite or epoxy tape or other prepreg material, for example and without limitation. The stiffness and other characteristics of the laminated composite panel may be controlled by varying the number of plies and the angles at which the plies are laid down to form the laminated composite panel.

In block 804, the laminated composite panel may be sealed in an autoclave using vacuum bagging. In block 806, the laminated composite panel may be cured. In block 808, the laminated composite panel may be subjected to a rough cutting process in which the laminated composite panel is cut into the general configuration of a laminated composite rod. The rough cutting process may be implemented using a water jet or other cutting process. In block 810, the laminated composite panel may be machined to form the laminated composite rod. In block 812, the laminated composite rod may be subjected to surface abrasion and/or other surface preparation techniques.

In block 814, the laminated composite rod may be inserted into a panel assembly stringer. In block 816, the fabric panel flanges of the panel assembly stringer may be stitched or otherwise attached to a skin panel assembly. In block 818, the panel assembly stringer may be sealed in vacuum bagging. In block 820, resin may be infused into the panel fabric of the panel assembly stringer. In block 822, the panel assembly stringer may be cured.

Referring next to FIGS. 9 and 10, embodiments of the disclosure may be used in the context of an aircraft manufacturing and service method 78 as shown in FIG. 9 and an aircraft 94 as shown in FIG. 10. During pre-production, exemplary method 78 may include specification and design 80 of the aircraft 94 and material procurement 82. During production, component and subassembly manufacturing 84 and system integration 86 of the aircraft 94 takes place. Thereafter, the aircraft 94 may go through certification and delivery 88 in order to be placed in service 90. While in service by a customer, the aircraft 94 may be scheduled for routine maintenance and service 92 (which may also include modification, reconfiguration, refurbishment, and so on).

Each of the processes of method 78 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 10, the aircraft 94 produced by exemplary method 78 may include an airframe 98 with a plurality of systems 96 and an interior 100. Examples of high-level systems 96 include one or more of a propulsion system 102, an electrical system 104, a hydraulic system 106, and an environmental system 108. Any number of other systems may be included. Although an aerospace example is shown, the principles of the invention may be applied to other industries, such as the automotive industry.

The apparatus embodied herein may be employed during any one or more of the stages of the production and service method 78. For example, components or subassemblies corresponding to production process 84 may be fabricated or manufactured in a manner similar to components or subassemblies produced while the aircraft 94 is in service. Also one or more apparatus embodiments may be utilized during the production stages 84 and 86, for example, by substantially expediting assembly of or reducing the cost of an aircraft 94. Similarly, one or more apparatus embodiments may be utilized while the aircraft 94 is in service, for example and without limitation, to maintenance and service 92.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A laminated composite rod, comprising:
a rod body having a generally circular or oval cross-section and comprising a plurality of laminated composite plies disposed at various orientations with respect to each other.

2. The laminated composite rod of claim 1 wherein said laminated composite plies are devoid of pultruded composite plies.

3. The laminated composite rod of claim 1 wherein said plurality of laminated composite plies is graphite tape, epoxy tape or a prepreg material.

4. A rod stitched efficient composite structure, comprising:
a stitched composite structure; and
a pre-cured laminated composite rod having a generally circular or oval cross-section and incorporated in said stitched composite structure.

5. The rod stitched efficient composite structure of claim 4 wherein said laminated composite rod is devoid of pultruded composite plies.

6. The rod stitched efficient composite structure of claim 5 wherein said laminated composite rod comprises a plurality of laminated composite plies disposed at different orientations with respect to each other.

7. The rod stitched efficient composite structure of claim 6 wherein said plurality of laminated composite plies plies is graphite tape, epoxy tape or a prepreg material.

8. The rod stitched efficient composite structure of claim 4 wherein said stitched composite structure comprises a pultruded rod stitched efficient structure panel assembly stringer.

9. The rod stitched efficient composite structure of claim 8 wherein said stringer comprises a pair of adjacent stringer panels and a panel wrap connecting said stringer panels and extending around said laminated composite rod.

10. The rod stitched efficient composite structure of claim 9 further comprising a skin panel assembly and a pair of panel flanges extending from said stringer panels, respectively, of said stringer and attached to said skin panel assembly.

11. The rod stitched efficient composite structure of claim 10 further comprising stitching attaching said stringer panels of said stringer to each other and said panel flanges to said skin panel assembly.

12. A laminated composite rod fabrication method, comprising:
providing a plurality of composite plies;
forming a laminated composite panel by laying down said composite plies;
curing said laminated composite panel; and
forming a laminated composite rod having a generally circular or oval cross-section from said laminated composite panel.

13. The method of claim 12 wherein said providing a plurality of composite plies comprises providing graphite tape, epoxy tape or a prepreg material.

14. The method of claim 12 wherein said laying down said composite plies comprises laying down said composite plies at various orientations with respect to each other.

15. The method of claim 12 wherein said forming a laminated composite rod from said laminated composite panel comprises rough cutting and machining said laminated composite panel.

16. The method of claim 12 further comprising subjecting said laminated composite rod to surface abrasion.

17. The method of claim 16 further comprising providing a stitched composite structure and inserting said laminated composite rod into said stitched composite structure.

18. The method of claim 17 further comprising curing said stitched composite structure.

19. The method of claim 17 wherein said providing a stitched composite structure and inserting said laminated composite rod into said stitched composite structure comprises providing a pultruded rod stitched efficient structure panel assembly stringer and inserting said laminated composite rod into said stringer.

20. The method of claim 19 further comprising providing a skin panel assembly and attaching said stringer to said skin panel assembly.

21. A laminated composite rod, comprising:
a rod body having a generally circular cross-section and comprising a plurality of laminated composite plies each selected from the group consisting of graphite tape, epoxy tape or a prepreg material devoid of pultruded composite plies and disposed at various orientations with respect to each other in said rod body.

22. A rod stitched efficient composite structure, comprising:
a skin panel assembly;
a pre-cured laminated composite rod comprising a rod body including a plurality of laminated composite plies selected from the group consisting of graphite tape, epoxy tape and a prepreg material devoid of pultruded composite plies and disposed at different orientations with respect to each other in said rod body; and
a rod stitched efficient structure panel assembly comprising a pair of adjacent stringer panels, a panel wrap connecting said stringer panels and extending around said laminated composite rod and a pair of panel flanges extending from said stringer panels and stitched to said skin panel assembly.

23. A laminated composite rod fabrication method, comprising:
providing a plurality of composite plies selected from the group consisting of graphite tape, epoxy tape and a prepreg material and devoid of pultruded composite plies;
forming a laminated composite panel by laying down said composite plies at various orientations with respect to each other;
curing said laminated composite panel;
forming a laminated composite rod from said laminated composite panel by cutting and machining said laminated composite panel;
subjecting said laminated composite rod to surface abrasion;
providing a rod stitched efficient structure panel assembly comprising a pair of adjacent stringer panels, a panel wrap connecting said stringer panels and a pair of panel flanges extending from said stringer panels;
inserting said laminated composite rod in said panel wrap of said stringer;
providing a skin panel assembly;
stitching said pair of panel flanges of said stringer to said skin panel assembly;
infusing resin into said stringer; and
curing said stringer.
